(19) United States
(12) Patent Application Publication
(10) Pub. No.: US 2025/0273395 A1
(43) Pub. Date: Aug. 28, 2025

(54) CERAMIC ELECTRONIC DEVICE AND MANUFACTURING METHOD OF THE SAME

(71) Applicant: TAIYO YUDEN CO., LTD., Tokyo (JP)

(72) Inventors: Yasutomo SUGA, Tokyo (JP); Yasuyuki INOMATA, Tokyo (JP)

(73) Assignee: TAIYO YUDEN CO., LTD., Tokyo (JP)

(21) Appl. No.: 19/178,004

(22) Filed: Apr. 14, 2025

Related U.S. Application Data
(63) Continuation of application No. PCT/JP2023/039886, filed on Nov. 6, 2023.

(30) Foreign Application Priority Data
Nov. 8, 2022 (JP) 2022-178853

(51) Int. Cl. H01G 4/12; H01G 4/008; H01G 4/30

(52) U.S. Cl. CPC H01G 4/1227; H01G 4/0085; H01G 4/30

(57) ABSTRACT

A ceramic electronic device includes a multilayer chip in which each of a plurality of dielectric layers and each of a plurality of internal electrode layers are alternately stacked. At least one of the plurality of dielectric layers comprises a first layer positioned at center thereof in a stacking direction and second layers each of which is adjacent to each of two internal electrode layers adjacent to the at least one of the plurality of dielectric layers and has an average grain size of dielectric grains smaller than that of the first layer.

### CROSS-REFERENCE TO RELATED APPLICATION

This application is a continuation application of PCT/JP2023/039886 filed on Nov. 6, 2023, which claims priority to Japanese Patent Application No. 2022-178853 filed on Nov. 8, 2022, the contents of which are herein wholly incorporated by reference.

### FIELD

A certain aspect of the present invention relates to a ceramic electronic device and a manufacturing method of the ceramic electronic device.

### BACKGROUND

As ceramic electronic devices such as multilayer ceramic capacitors become smaller and larger capacity, structures have been disclosed in which the dielectric layers and internal electrode layers are made thinner and multi-layered (see, for example, Japanese Patent Application Publication No. 2008-305844 and Japanese Patent Application Publication No. 2006-319205).

### SUMMARY OF THE INVENTION

According to an aspect of the present invention, there is provided a ceramic electronic device including: a multilayer chip in which each of a plurality of dielectric layers and each of a plurality of internal electrode layers are alternately stacked, wherein at least one of the plurality of dielectric layers comprises a first layer positioned at center thereof in a stacking direction and second layers each of which is adjacent to each of two internal electrode layers adjacent to the at least one of the plurality of dielectric layers and has an average grain size of dielectric grains smaller than that of the first layer.

According to another aspect of the present invention, there is provided a manufacturing method of a ceramic electronic device including: forming a multilayer structure by alternately stacking each of a plurality of dielectric green sheets, in which a first green sheet containing a ceramic material is stacked on an upper surface and a lower surface thereof with a second green sheet containing a ceramic material having an average particle size smaller than an average particle size of the ceramic material of the first green sheet, and each of a plurality of internal electrode patterns for internal electrode layers; and firing the multilayer structure.

### BRIEF DESCRIPTION OF THE DRAWINGS

FIG. 1 illustrates a perspective view of a multilayer ceramic capacitor in which a cross section of a part of the multilayer ceramic capacitor is illustrated;

FIG. 2 illustrates a cross sectional view taken along a line A-A of FIG. 1;

FIG. 3 illustrates a cross sectional view taken along a line B-B of FIG. 1;

FIG. 4 illustrates a continuity modulus;

FIG. 5 illustrates an enlarged view of an XZ cross section;

FIG. 6 illustrates an enlarged view of an XZ cross section;

FIG. 7 illustrates a manufacturing method of a multilayer ceramic capacitor; and

FIG. 8A to FIG. 8C illustrate a stacking process.

### DETAILED DESCRIPTION

Thinning the internal electrode layer may cause discontinuities in the internal electrode layer, reducing the continuity modulus.

A description will be given of an embodiment with reference to the accompanying drawings.

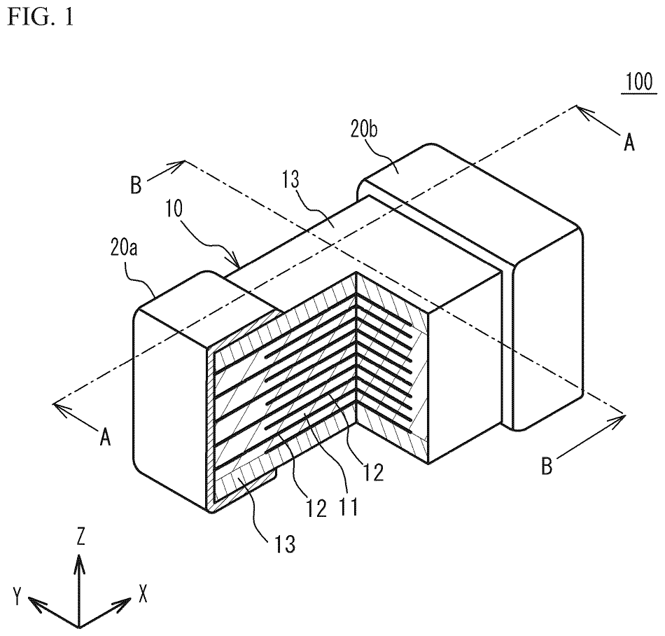

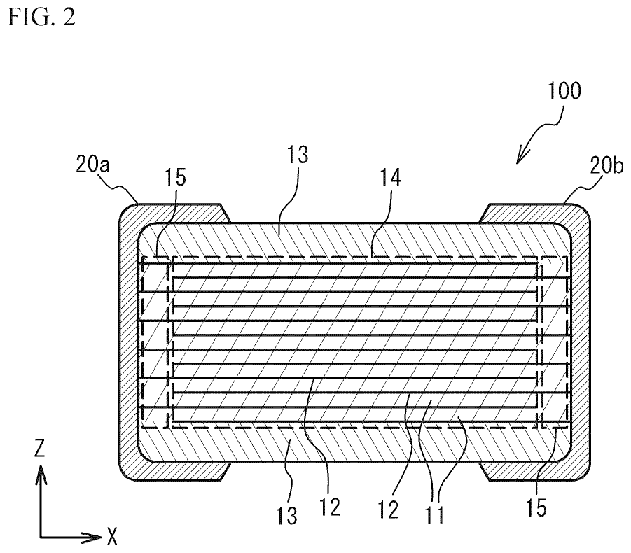

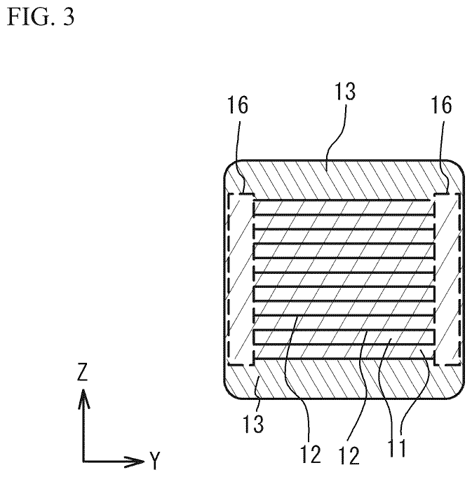

(Embodiment) FIG. 1 illustrates a perspective view of a multilayer ceramic capacitor 100 in accordance with an embodiment, in which a cross section of a part of the multilayer ceramic capacitor 100 is illustrated. FIG. 2 illustrates a cross sectional view taken along a line A-A of FIG. 1. FIG. 3 illustrates a cross sectional view taken along a line B-B of FIG. 1. As illustrated in FIG. 1 to FIG. 3, the multilayer ceramic capacitor 100 includes a multilayer chip 10 having a rectangular parallelepiped shape, and a pair of external electrodes 20a and 20b that are respectively provided at two end faces of the multilayer chip 10 facing each other. In four faces other than the two end faces of the multilayer chip 10, two faces other than an upper face and a lower face of the multilayer chip 10 in a stacking direction are referred to as side faces. The external electrodes 20a and 20b extend to the upper face, the lower face and the two side faces of the multilayer chip 10. However, the external electrodes 20a and 20b are spaced from each other.

In FIG. 1 to FIGS. 3, 1 to 3, a Z-axis direction is the direction in which internal electrode layers 12 face each other, the stacking direction of the dielectric layers 11, and the direction in which the upper face and the lower face of the multilayer chip 10 face each other. An X-axis direction is the length direction of the multilayer chip 10, the direction in which the two end faces of the multilayer chip 10 face each other, the direction in which the external electrodes 20a and 20b face each other, and the longitudinal direction in which the dielectric layers 11 extend. A Y-axis direction is the width direction of the internal electrode layers 12, and the direction in which the two side faces other than the two end faces of the four side faces of the multilayer chip 10 face each other.

The multilayer chip 10 has a configuration in which dielectric layers 11 containing a ceramic material that functions as a dielectric and the internal electrode layers 12 of which a main component is a metal are alternately stacked. In other words, the multilayer chip 10 includes the plurality of internal electrode layers 12 facing each other, and the dielectric layers 11 sandwiched between the plurality of internal electrode layers 12. The edges of the internal electrode layers 12 in a direction in which the internal electrode layers extend are alternately exposed to the first end face of the multilayer chip 10 on which the external electrode 20a is provided and the second end face on which the external electrode 20b is provided. The internal electrode layer 12 connected to the external electrode 20a is not connected to the external electrode 20b, and the internal electrode layer 12 connected to the external electrode 20b is not connected to the external electrode 20a. As a result, each of the internal electrode layers 12 is alternately conductive to the external electrode 20a and the external electrode 20b. In addition, in the multilayer structure of the dielectric layers 11 and the internal electrode layers 12, the internal electrode layers 12 are arranged on both outermost layers in the stacking direction, and the internal electrode layers 12 of the outermost layers are covered by cover layers 13. The cover layers 13 are mainly composed of a ceramic material. For example, the cover layers 13 may have the same composition as the dielectric layers 11 or may have a different composition.

A main component of the dielectric layer 11 is a ceramic material having a perovskite structure expressed by a general formula ABO₃. The perovskite structure includes ABO₃-a having an off-stoichiometric composition. For example, the ceramic material is such as BaTiO₃ (barium titanate), CaZrO₃ (calcium zirconate), CaTiO₃ (calcium titanate), SrTiO₃ (strontium titanate), MgTiO₃ (magnesium titanate), Ba_{1-x-y}CaₓSr_{y}Ti_{1-z}Zr₂O₃ (0≤x≤1, 0≤y≤1, 0≤z≤1) having a perovskite structure. Ba_{1-x-y}CaₓSr_{y}Ti_{1-z}Zr₂O₃ may be barium strontium titanate, barium calcium titanate, barium zirconate, barium titanate zirconate, calcium titanate zirconate, barium calcium titanate zirconate or the like.

Of these ceramic materials, it is preferable to use a ferroelectric material with a relative dielectric constant of 1000 or more.

Additives may be added to the dielectric layer 11. As additives to the dielectric layer 11, an oxide of Mg (magnesium), Mn (manganese), Mo (molybdenum), vanadium (V), chromium (Cr), or a rare earth element (Y (yttrium), Sm (samarium), Eu (europium), Gd (gadolinium), Tb (terbium), Dy (dysprosium), Ho (holmium), Er (erbium), Tm (thulium) or Yb (ytterbium), or an oxide of Co (cobalt), Ni (nickel), Li (lithium), B (boron), Na (sodium), K (potassium) or Si (silicon), or a glass including cobalt, nickel, lithium, boron, sodium, potassium or silicon.

The internal electrode layers 12 are mainly composed of base metals such as nickel (Ni), copper (Cu), or tin (Sn), or alloys thereof. As the main component of the internal electrode layers 12, noble metals such as platinum (Pt), palladium (Pd), silver (Ag), or gold (Au), or alloys containing these metals, may be used.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 0.6 mm, a width of 0.3 mm, and a height of 0.110 mm. The multilayer ceramic capacitor 100 may have a length of 1.0 mm, a width of 0.5 mm, and a height of 0.5 mm. The multilayer ceramic capacitor 100 may have a length of 1.0 mm, a width of 0.5 mm, and a height of 0.1 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes. For example, the length and width of these dimensions may be interchanged. The multilayer ceramic capacitor 100 may be a three-terminal multilayer ceramic capacitor having three external electrodes.

The thickness of each of the dielectric layers 11 in the Z-axis direction is, for example, 0.3 μm or less and 20 μm or less, 0.3 μm or less and 10 μm or less, or 0.4 μm or less and 8 μm or less, or 0.5 μm or less and 5 μm or less. The thickness of each of the dielectric layers 11 in the Z-axis direction can be measured by exposing a cross section of the multilayer ceramic capacitor 100 of FIG. 2 by mechanical polishing, capturing an image of the cross section with a SEM (scanning electron microscope), measuring the thickness at 10 points of the dielectric layer 11, and deriving the average value of all the measurement points.

The thickness of the internal electrode layer 12 in the Z-axis direction is, for example, 0.1 μm or less and 2 μm or less, 0.2 μm or less and 1 μm or less, or 0.3 μm or less and 0.8 μm or less. The thickness of the internal electrode layer 12 can be measured by exposing a cross section of the multilayer ceramic capacitor 100 of FIG. 2 by mechanical polishing, capturing an image of the cross section with a SEM (scanning electron microscope), measuring the thickness at 10 points of the internal electrode layer 12, and deriving the average value of all the measurement points.

In the multilayer ceramic capacitor 100, the number of layers of the internal electrode layers 12 is, for example, about 50 or more and 500 or less. Also, in the multilayer ceramic capacitor 100, the layer density of the internal electrode layers 12 is about 20 layers/mm or more and 1500 layers/mm or less.

As illustrated in FIG. 2, a section, in which a set of the internal electrode layers 12 connected to the external electrode 20a face another set of the internal electrode layers 12 connected to the external electrode 20b, is a section generating electrical capacity in the multilayer ceramic capacitor 100. Accordingly, the section is referred to as a capacity section 14. That is, the capacity section 14 is a section in which the internal electrode layers next to each other being connected to different external electrodes face each other.

A section, in which the internal electrode layers 12 connected to the external electrode 20a face each other without sandwiching the internal electrode layer 12 connected to the external electrode 20b, is referred to as an end margin 15. A section, in which the internal electrode layers 12 connected to the external electrode 20b face each other without sandwiching the internal electrode layer 12 connected to the external electrode 20a is another end margin 15. That is, the end margin 15 is a section in which a set of the internal electrode layers 12 connected to one external electrode face each other without sandwiching the internal electrode layer 12 connected to the other external electrode. The end margins 15 are sections that do not generate electrical capacity in the multilayer ceramic capacitor 100. The end margin 15 may have the same composition as the dielectric layer 11 of the capacity section 14, or may have a different composition.

As illustrated in FIG. 3, a section of the multilayer chip 10 from the two sides thereof to the internal electrode layers 12 is referred to as a side margin 16. That is, the side margin 16 is a section covering edges of the stacked internal electrode layers 12 in the extension direction toward the two side faces. The side margin 16 does not generate electrical capacity. The side margin 16 may have the same composition as the dielectric layer 11 of the capacity section 14, or may have a different composition.

In this structure, if the number of layers is increased to increase the size and capacity, the internal electrode layers 12 will be made thinner. However, if the internal electrode layers 12 are made thinner, the continuity of the internal electrode layers 12 will decrease. Here, a description will be given of the continuity modulus, which is an index of the continuity of the internal electrode layers 12.

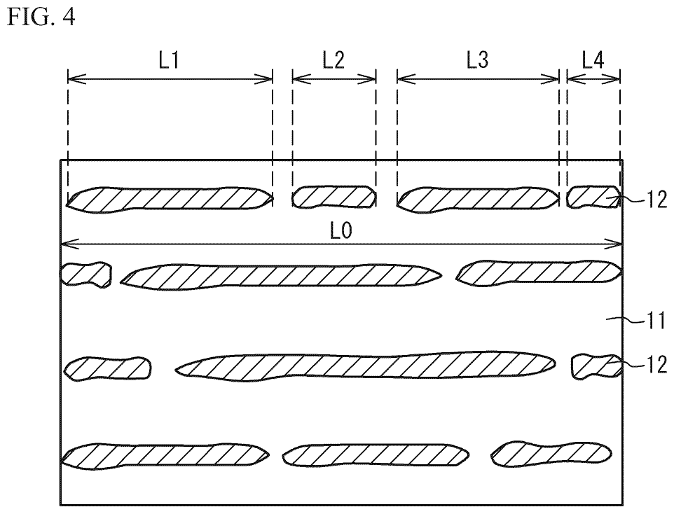

FIG. 4 is a diagram illustrating the continuity modulus. As illustrated in FIG. 4, in an observation area of length L0 in one of the internal electrode layers 12, the lengths L1, L2, . . . , Ln of the metal parts are measured and summed up, and the ratio of the metal parts, Σ Ln/L0, can be defined as the continuity modulus of that layer. The closer this continuity modulus is to 100%, the better the continuity of the internal electrode layers 12.

The multilayer ceramic capacitor 100 according to this embodiment has a configuration that can improve the continuity of the internal electrode layers 12.

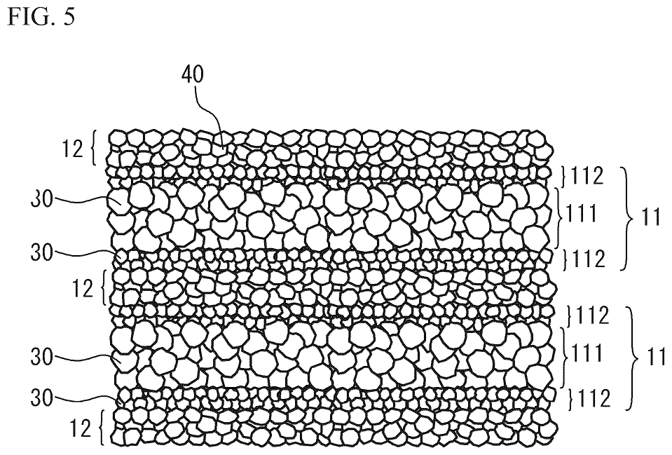

FIG. 5 is an enlarged view of the XZ cross section. FIG. 5 illustrates an enlarged view of the XZ cross section of the capacity section 14 as an example. As illustrated in FIG. 5, the dielectric layer 11 has a structure in which a plurality of dielectric grains 30 are sintered. In this embodiment, the dielectric layer 11 has a first layer 111 in the center in the Z-axis direction, and a second layer 112 at both ends in the Z-axis direction. That is, the dielectric layer 11 has a configuration in which one first layer 111 is sandwiched between two second layers 112. The second layer 112 is adjacent to the internal electrode layer 12. The average grain size of the dielectric grains 30 contained in the dielectric layer 11 is larger in the first layer 111 than in the second layer 112.

According to this configuration, the section of the dielectric layer 11 that contacts the adjacent internal electrode layer 12 is the second layer 112. Since the average grain size of the dielectric grains 30 in the second layer 112 is small, the surface roughness of the second layer 112 is small, and as a result, the internal electrode layer 12 in contact with the second layer 112 is also flat, and the continuity modulus of the internal electrode layer 12 is increased.

If the average grain size of the dielectric grains 30 is small throughout the dielectric layer 11, the dielectric constant of the dielectric layer 11 will be low. However, in this embodiment, the first layer 111 is provided in the center of the dielectric layer 11. This allows the dielectric constant of the dielectric layer 11 to be maintained high.

If the average grain size of the dielectric grains 30 in the second layer 112 is not small enough, the surface roughness of the second layer 112 may not be sufficiently small. Therefore, it is preferable to set an upper limit on the average grain size in the second layer 112. In this embodiment, the average grain size in the second layer 112 is preferably 0.02 μm or less, more preferably 0.018 μm or less, and even more preferably 0.016 μm or less.

Furthermore, the upper limit of the grain size of each dielectric grain 30 contained in the second layer 112 is preferably 0.025 μm or less, more preferably 0.023 μm or less, and even more preferably 0.021 μm or less.

On the other hand, if the average grain size of the dielectric grains 30 in the second layer 112 is too small, there is a risk of aggregation during dispersion. Therefore, it is preferable to set a lower limit for the average grain size in the second layer 112. In this embodiment, the average grain size in the second layer 112 is preferably 0.010 μm or more, more preferably 0.012 μm or more, and even more preferably 0.014 μm or more.

Furthermore, the lower limit of the grain size of the dielectric grains 30 contained in the second layer 112 is preferably 0.005 μm or more, more preferably 0.007 μm or more, and even more preferably 0.009 μm or more.

If the average grain size of the dielectric grains 30 in the first layer 111 is not large enough, the dielectric layer 11 may not have a sufficient relative dielectric constant. Therefore, it is preferable to set a lower limit on the average grain size in the first layer 111. In this embodiment, the average grain size in the first layer 111 is preferably 0.035 μm or more, more preferably 0.037 μm or more, and even more preferably 0.039 μm or more.

Furthermore, the lower limit on the grain size of the dielectric grains 30 contained in the first layer 111 is preferably 0.03 μm or more, more preferably 0.032 μm or more, and even more preferably 0.034 μm or more.

On the other hand, if the average grain size of the dielectric grains 30 in the first layer 111 is too large, defects may easily occur when forming a thin sheet. Therefore, it is preferable to set an upper limit on the average grain size in the first layer 111. In this embodiment, the average grain size in the first layer 111 is preferably 0.08 μm or less, more preferably 0.078 μm or less, and even more preferably 0.076 μm or less.

Furthermore, the upper limit of the grain size of the dielectric grains 30 contained in the first layer 111 is preferably 0.085 μm or less, more preferably 0.083 μm or less, and even more preferably 0.081 μm or less.

In the dielectric layer 11, the thickness of the first layer 111 is 1/30 to ¼ the thickness of the dielectric layer 11, and the thickness of the second layer 112 is 1/20 to 1/50 the thickness of the dielectric layer 11.

The grain size of the dielectric grains 30 can be measured by measuring the maximum diameter of the dielectric grains observed in the SEM or TEM photograph of the XZ cross section. The average grain size of the dielectric grains 30 can be measured by measuring the average value of the maximum diameters of the dielectric grains observed in the SEM or TEM photograph of the XZ cross section.

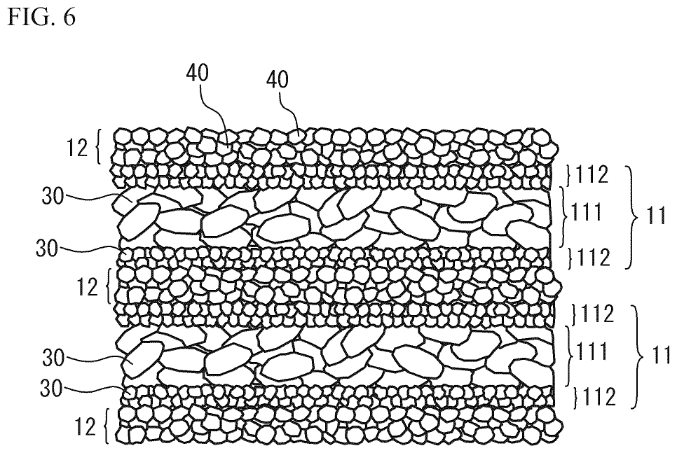

In order to increase the relative dielectric constant of the dielectric layer 11 while preventing the dielectric layer 11 from becoming thick, it is preferable that the dielectric grains 30 of the first layer 111 have a flat shape in the XZ cross section, as illustrated in FIG. 6. In this embodiment, among the dielectric grains 30 observed in the XZ cross section, grains whose maximum length is three times or more than their minimum length are defined as grains having a flat shape.

For example, in the XZ cross section, it is preferable that 60% or more of all the dielectric grains 30 contained in the first layer 111 have a flat shape, more preferably 55% or more have a flat shape, and even more preferably 50% or more have a flat shape.

In the first layer 111, it is preferable that the dielectric grains 30 having the flat shape are oriented. Specifically, it is preferable that the angle between the X-axis direction (the direction in which the dielectric layer 11 extends) and the average direction of the long diameter of each dielectric grain 30 is +20° or less. In this configuration, the relative dielectric constant of the dielectric layer 11 can be increased without increasing the thickness of the dielectric layer 11. The average direction of each dielectric grain 30 can be measured by measuring the average value of the long diameter of the dielectric grains observed in an SEM photograph or TEM photograph of the XZ cross section.

In the multilayer ceramic capacitor 100 according to this embodiment, it is sufficient that at least one of the dielectric layers 11 includes the first layer 111 and the second layer 112. The higher the ratio of the dielectric layers 11 that include the first layer 111 and the second layer 112 among all the dielectric layers 11, the more preferable. In this embodiment, of all the dielectric layers 11, it is preferable that 80% or more of the dielectric layers 11 have the first layer 111 and the second layer 112, it is more preferable that 85% or more of the dielectric layers 11 have the first layer 111 and the second layer 112, and it is even more preferable that 90% or more of the dielectric layers 11 have the first layer 111 and the second layer 112.

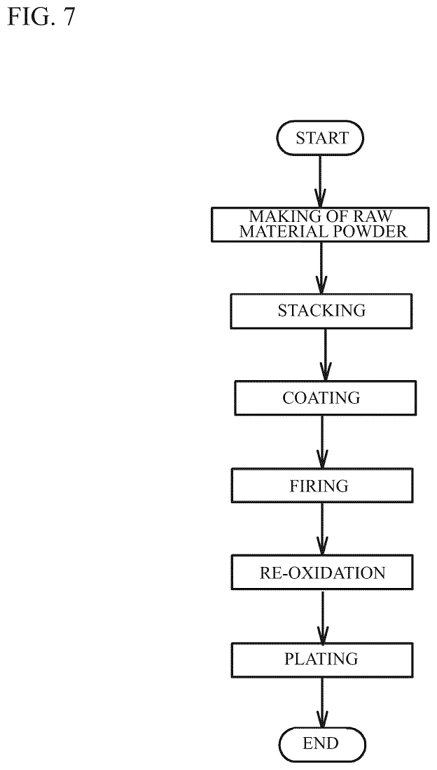

Next, a description will be given of a manufacturing method of the multilayer ceramic capacitors 100. FIG. 7 illustrates a manufacturing method of the multilayer ceramic capacitor 100.

(Making process of raw material powder) A dielectric material for forming the dielectric layer 11 is prepared. The dielectric material includes the main component ceramic of the dielectric layer 11. Generally, an A site element and a B site element are included in the dielectric layer 11 in a sintered phase of grains of ABO₃. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate. Various methods can be used as a synthesizing method of the ceramic structuring the dielectric layer 11. For example, a solid-phase method, a sol-gel method, a hydrothermal method or the like can be used. The embodiments may use any of these methods.

An additive compound may be added to the resulting ceramic powder, in accordance with purposes. The additive compound may be an oxide of magnesium (Mg), manganese (Mn), molybdenum (Mo), vanadium (V), chromium (Cr), a rare earth element (yttrium (Y), samarium (Sm), europium (Eu), gadolinium (Gd), terbium (Tb), dysprosium ‘Dy), holmium (Ho), erbium (Er), thulium (Tm) or ytterbium (Yb)), or an oxide containing cobalt (Co), nickel (Ni), lithium (Li), boron (B), sodium (Na), potassium (K) or silicon (Si), or glasses containing cobalt, nickel, lithium, boron, sodium, potassium or silicon.

For example, the resulting ceramic raw material powder is wet-blended with additives and is dried and crushed. Thus, a ceramic material is obtained. For example, the particle diameter may be adjusted by crushing the resulting ceramic material as needed. Alternatively, the grain diameter of the resulting ceramic power may be adjusted by combining the crushing and classifying. With the processes, a dielectric material is obtained.

Note that the particle size of the dielectric material used to form the first layer 111 is made large, and the particle size of the dielectric material used to form the second layer 112 is made small.

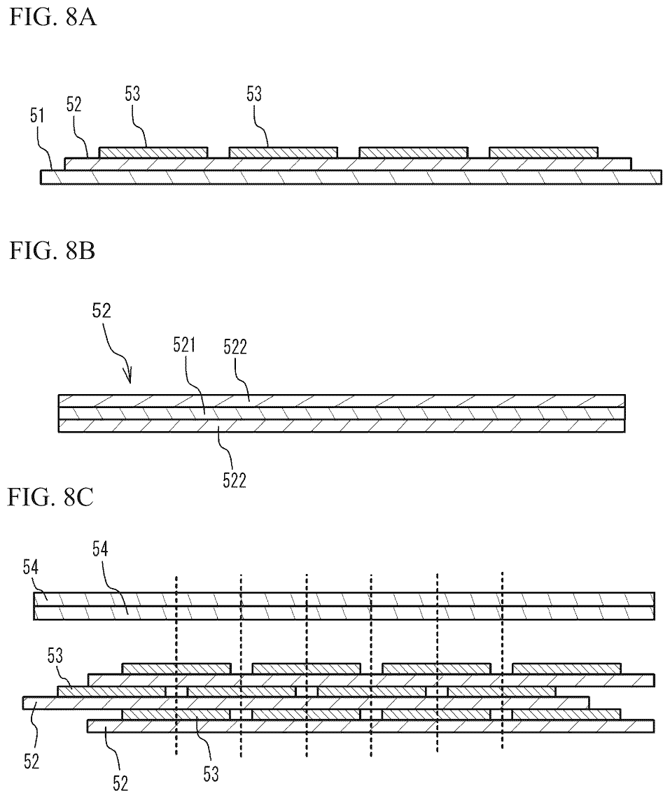

(Stacking process) Next, a binder such as polyvinyl butyral (PVB) resin, an organic solvent such as ethanol or toluene, and a plasticizer are added to the resulting dielectric material and wet-blended. With use of the resulting slurry, a dielectric green sheet 52 is formed on a base material 51 as illustrated in FIG. 8A by, for example, a die coater method or a doctor blade method, and then dried. The base material 51 is, for example, PET (polyethylene terephthalate) film.

FIG. 8B is a diagram illustrating the details of the dielectric green sheet 52. As illustrated in FIG. 8B, the dielectric material for forming the second layer 112 is applied to form a small particle size green sheet 522, the dielectric material for forming the first layer 111 is applied thereon to form a large particle size green sheet 521, and the dielectric material for forming the second layer 112 is applied thereon to form the small particle size green sheet 522. Note that when the first layer 111 is applied using spin coating, the long diameter direction of the flat ceramic powder tends to be oriented close to the in-plane direction.

Alternatively, the small particle size green sheet 522 may be formed by depositing a dielectric material for forming the second layer 112 by a vacuum deposition method such as sputtering, the large particle size green sheet 521 may be formed thereon by depositing a dielectric material for forming the first layer 111 by a vacuum deposition method, and the small particle size green sheet 522 may be formed thereon by depositing a dielectric material for forming the second layer 112 by a vacuum deposition method.

Next, the internal electrode pattern 53 is formed on the dielectric green sheet 52. In FIG. 8A, as an example, four layers of internal electrode patterns 53 are formed at predetermined intervals on the dielectric green sheet 52. The dielectric green sheet 52 on which the internal electrode patterns 53 are formed is regarded as a stack unit.

For the internal electrode patterns 53, a metal paste of the main component metal of the internal electrode layer 12 is used. The film formation method may be printing, sputtering, vapor deposition, or the like. The shape of each internal electrode pattern 53 corresponds to the internal electrode layer 12.

Next, while peeling off the dielectric green sheet 52 from the base material 51, the stack units are stacked as illustrated in FIG. 8C.

Next, a predetermined number of cover sheets 54 (for example, 2 to 10 layers) are stacked on the top and bottom of the multilayer structure obtained by stacking the stack units, and are thermocompression bonded, and cut to the predetermined chip dimensions (for example, 1.0 mm×0.5 mm). In the example of FIG. 8C, cutting is performed along the dotted line. The cover sheet 54 may be of the same composition as the dielectric green sheet 52, or may contain different additives.

(Coating process) After the ceramic multilayer structure obtained in this way is subjected to a binder removal process in an N₂ atmosphere, a metal paste that will become the base layer of the external electrodes 20a and 20b is coated by a dipping method or the like. The metal paste contains a co-material. For example, the metal paste is coated on the two end faces of the multilayer structure where the internal electrode pattern 53 is exposed.

(Firing process) After that, the resulting multilayer structure is fired for 10 minutes to 2 hours in a reductive atmosphere having an oxygen partial pressure of 10-5 to 10-8 atm in a temperature range of 1100 degrees C. to 1300 degrees C.

(Re-oxidizing process) After that, a re-oxidation process may be performed in N₂ gas atmosphere in a temperature range from 600° C. to 1000° C.

(Plating process) Thereafter, a plated layer may be formed on the base layer by plating. Through the above steps, the multilayer ceramic capacitor 100 is completed.

According to this embodiment, the small particle size green sheet 522 is formed, the large particle size green sheet 521 is formed thereon, and the small particle size green sheet 522 is formed thereon to form the dielectric green sheet 52, so that the first layer 111 and the second layer 112 can be formed in the sintered dielectric layer 11. This makes it possible to improve the continuity modulus of the internal electrode layer 12 while maintaining a high relative dielectric constant of the dielectric layer 11.

In the embodiments, the multilayer ceramic capacitor is described as an example of ceramic electronic devices. However, the embodiments are not limited to the multilayer ceramic capacitor. For example, the embodiments may be applied to another electronic device such as varistor or thermistor.

Although the embodiments of the present invention have been described in detail, it is to be understood that the various changes, substitutions, and alterations could be made hereto without departing from the spirit and scope of the invention.

What is claimed is:

1. A ceramic electronic device comprising:
a multilayer chip in which each of a plurality of dielectric layers and each of a plurality of internal electrode layers are alternately stacked,
wherein at least one of the plurality of dielectric layers comprises a first layer positioned at center thereof in a stacking direction and second layers each of which is adjacent to each of two internal electrode layers adjacent to the at least one of the plurality of dielectric layers and has an average grain size of dielectric grains smaller than that of the first layer.

2. The ceramic electronic device as claimed in claim 1, wherein the average grain size of the dielectric grains in the second layers is 0.02 μm or less.

3. The ceramic electronic device as claimed in claim 1, wherein grain sizes of the dielectric grains in the second layers is 0.025 μm or less.

4. The ceramic electronic device as claimed in claim 1, wherein the average grain size of the dielectric grains in the first layer is 0.035 μm or more.

5. The ceramic electronic device as claimed in claim 1, wherein grain sizes of the dielectric grains in the first layers is 0.03 μm or more.

6. The ceramic electronic device as claimed in claim 1, wherein grain sizes of the dielectric grains in the first layers is 0.08 μm or less.

7. The ceramic electronic device as claimed in claim 1, wherein grain sizes of the dielectric grains in the first layers is 0.085 μm or less.

8. The ceramic electronic device as claimed in claim 1, wherein the first layer includes flat shape grains of which a maximum length is three times or more than a minimum length, in a cross section including a stacking direction.

9. The ceramic electronic device as claimed in claim 8, wherein 60% or more of the dielectric grains of the first layer are the flat shape grains.

10. The ceramic electronic device as claimed in claim 9, wherein an angle between an average direction of long diameters of the flat shape grains and a direction in which the dielectric layer extends is ±20° or less, in a cross section including a stacking direction.

11. The ceramic electronic device as claimed in claim 1, wherein a main component of the plurality of dielectric layers is a ferroelectric material.

12. The ceramic electronic device as claimed in claim 1, wherein 80% layers or more of the plurality of dielectric layers has the first layer and the second layers.

13. A manufacturing method of a ceramic electronic device comprising:
forming a multilayer structure by alternately stacking each of a plurality of dielectric green sheets, in which a first green sheet containing a ceramic material is stacked on an upper surface and a lower surface thereof with a second green sheet containing a ceramic material having an average particle size smaller than an average particle size of the ceramic material of the first green sheet, and each of a plurality of internal electrode patterns for internal electrode layers; and
firing the multilayer structure.
